(19) United States
(12) Patent Application Publication
(10) Pub. No.: US 2026/0202803 A1
(43) Pub. Date: Jul. 16, 2026

(54) Method for Training a Machine Learning Model for Determining Optimal Parameter Settings of a Control Device of a Vehicle

(71) Applicant: Robert Bosch GmbH, Stuttgart (DE)

(72) Inventors: Achim Romer, Weinsberg (DE); Nicole Ventsch, Ludwigsburg (DE)

(21) Appl. No.: 19/446,556

(22) Filed: Jan. 12, 2026

(30) Foreign Application Priority Data
Jan. 16, 2025 (DE) 10 2025 101 465.5

(51) Int. Cl. G05B 13/02

(52) U.S. Cl. CPC G05B 13/027

(57) ABSTRACT

A method is disclosed for training a machine learning model, in particular an agent model, for determining optimal parameter settings of a control device of a vehicle, in particular based on reinforcement learning. The method includes (i) simulating and/or capturing measurement curves based on the parameter settings suggested by the agent and providing ideal measurement curves, (ii) calculating a reward signal by comparing the simulated and/or captured measurement curves with previously known ideal measurement curves, wherein the reward signal quantifies the deviation between the simulated and/or captured measurement curves and the ideal measurement curves, (iii) adjusting a policy of the agent model based on the reward signal to select future parameter settings to minimize the deviation, and (iv) repeating the steps of simulation or capture, reward calculation, and policy adjustment until a convergence condition occurs where the simulated and/or captured measurement curves are within a predetermined tolerance range of the ideal measurement curves.

This application claims priority under 35 U.S.C. § 119 to patent application no. DE 10 2025 101 465.5, filed on Jan. 16, 2025 in Germany, the disclosure of which is incorporated herein by reference in its entirety.

The disclosure relates to a method for training a machine learning model, in particular an agent model, for determining optimal parameter settings of a control device of a vehicle, in particular based on reinforcement learning. The disclosure relates to a method for training a machine learning model for determining optimal parameter settings of a control device of a vehicle, in particular based on supervised learning.

### BACKGROUND

The development of modern vehicles and their control devices is a complex and resource-intensive process that requires precise tuning of various functional parameters. These parameters significantly affect the behavior of the vehicle and must be selected as optimally as possible depending on the respective function. The aim is to ensure a harmonious interaction of the systems that meets both the technical requirements and the subjective expectations of the driver.

Different approaches exist to determine these functional parameters. Optimization methods are often used in which target parameters, such as fuel consumption or performance, are improved by systematically adjusting the parameters. An alternative method is manual testing where trial-and-error is used to determine the optimal values for the desired function. This method is used in particular in the case of drivability functions, since no clearly defined target parameters exist here. Instead, the focus is on the subjective perception of a comfortable and appropriate driving experience that varies significantly depending on the type of vehicle, for example, a sports car or economy car.

However, both the manual and the optimized parameter determination have challenges in common. They are time and cost intensive because they typically require numerous test drives. The high amount of effort results from the need to cover various scenarios and driving conditions to ensure the robustness and reliability of the determined parameters. In light of this, developing more efficient methods for determining parameters is a central starting point for reducing effort while still improving the quality of vehicle functions.

An exemplary prior art document is EP 3 916 496 A1. The system shown therein enables the generation and optimization of models for industrial processes by using simulated and real-world input data to generate behavioral data that train a machine learning model. The selection and training of the models is based on data and sensitivity in order to maximize efficiency and accuracy. “Highly informative” data points are generated by way of Bayesian Optimization by evaluating input value trajectories that maximize the sensitivity of the model response to the parameters.

The object of the disclosure is to provide an improved method and/or apparatus in this respect.

The problem is solved with a method according to the description set forth below. The problem is solved with an apparatus according to the description set forth below. The disclosure relates to a computer program product according to the description set forth below.

### SUMMARY

According to a preferred aspect, a method for training a machine learning model, in particular an agent model, is proposed for determining optimal parameter settings of a control device of a vehicle, in particular based on reinforcement learning. The method comprises the steps of: providing an agent model that generates actions in the form of parameter settings for the control device; initializing the agent model with random or predetermined parameter settings; simulating or capturing measurement curves based on the parameter settings suggested by the agent and providing ideal measurement curves; calculating a reward signal by comparing the simulated and/or captured measurement curves with previously known ideal measurement curves, wherein the reward signal quantifies the deviation between the simulated and/or captured measurement curves and ideal measurement curves; adjusting a policy of the agent model based on the reward signal to select future parameter settings to minimize the deviation; and repeating the steps of simulation or capture, reward calculation, and policy adjustment until a convergence condition occurs where the simulated and/or captured measurement curves are within a predetermined tolerance range of the ideal measurement curves. Furthermore, a trained agent model is provided.

The method is preferably based on reinforcement learning in which an agent model is trained to find optimal parameter settings for a system by interacting with an environment. The agent model preferably generates actions in the form of parameter settings that serve as the basis for the next iteration. The parameter settings are preferably generated initially randomly or based on predetermined starting values to create a broad initial basis. Based on these parameter settings, preferably measurement curves are captured either by simulation or by direct measurement. The generated or measured measurement curves are preferably compared to ideal measurement curves to assess the quality of the proposed parameter settings. The assessment preferably occurs by calculating a reward signal that quantifies the deviation between the simulated or measured measurement curves and the ideal measurement curves. This reward signal is preferably utilized to adjust the agent model policy and optimize future parameter settings. The adjustment process is preferably iterative, with the agent model making better decisions with each iteration that bring the measurement curves closer to the ideal measurement curves. The iterations are preferably repeated until a predetermined convergence condition is attained. The convergence condition is preferably defined by a threshold value that provides a sufficient match between the simulated or measured measurement curves and the ideal measurement curves.

Furthermore, in another aspect, a method is proposed for training a machine learning model for determining optimal parameter settings of a control device of a vehicle, in particular based on supervised learning. The method comprises the steps of: providing a training data set comprising a plurality of input data in the form of parameter settings as well as associated measurement curves and ideal measurement curves; training the machine learning model by adjusting model parameters, wherein the machine learning model is trained to predict parameter settings using the measurement curves and the ideal measurement curves; calculating an error signal based on a deviation between the predicted measurement curves and the ideal measurement curves; optimizing the model parameters by minimizing the error signal using an optimization algorithm; and repeating the training process until a convergence condition occurs where the machine learning model outputs parameter settings leading to measurement curves that are within a predetermined tolerance range of the ideal measurement curves. Furthermore, the trained machine learning model is provided.

The training method is preferably based on supervised learning in which a machine learning model is trained to predict optimal parameter settings for the control device. The training data set preferably comprises a plurality of input data in the form of parameter settings as well as associated measurement curves and ideal measurement curves. The measurement curves are preferably compared to the ideal measurement curves to assess the deviation. This assessment preferably occurs by way of an error function that calculates the error signal. The error signal is preferably utilized to update the model parameters by way of an optimization algorithm to minimize the deviation. The training process is preferably performed iteratively so that the model is gradually improved. The repetitions of the training process preferably end when a convergence condition is attained. The convergence condition is preferably defined by a sufficient match of the predicted measurement curves to the ideal measurement curves within a predetermined tolerance range.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to another aspect, an apparatus for training a machine learning model for determining optimal parameter settings of a control device of a vehicle is proposed, wherein the apparatus comprises: a computational unit for implementing a present method according to one of its embodiments; a data interface to provide simulated and/or captured measurement curves and ideal measurement curves; and an output unit for outputting the trained parameter settings. The apparatus can also be the control unit.

The training parameters can be generated by determining randomized values for the parameters to be determined, for example, in particular within a predetermined range of validity, which can be defined by hardware limitations of the control device. Furthermore, the measurement curves associated with the training parameters are generated using a simulation of the behavior of the control device as a function of the randomized parameters and/or by way of a (real) drive or testing with a test vehicle using a control device that has been calibrated with the randomized parameters. The capture of training data is repeated in the event of supervised training until achieving a data set size corresponding to the complexity of the function to be calibrated.

The machine learning model may be (pre)trained using the generated training data. The inputs of the machine learning model are the, preferably vectorized, measurement curves, and the outputs of the machine learning model are the functional parameters of the control device. The machine learning model is applied to the optimal measurement curve. The returned parameters are preferably subsequently fed into a simulation, and the simulated measurement curves are compared to the optimal measurement curves. As long as their difference (e.g., the squared deviation of the curves from each other) is above a predetermined value, preferably at least in the reinforcement approach, each newly generated parameter measurement curve pair is used to further train the machine learning model. This is preferably repeated until the deviation of the simulated curve from the optimal curve is below a predetermined threshold value, i.e. the convergence condition. If the deviation of the simulated curve from the optimal curve is below the threshold value, the training is preferably ended and the parameters most recently predicted by the machine learning model are returned. These parameters can then be used for the calibration of the control device to perform the respective function.

Using the method, determining functional parameters may also be automated by subjective functions by training a machine learning model on simulation data and/or on real-world driving data. The machine learning model may then subsequently determine the parameters of the control device, which then result in a predetermined driving behavior. In the present case, the determination of functional parameters for the control device is automated by defining one or more desired target curves and/or by combining simulation data and/or measurement data from test drives with the machine learning model.

The present method may be used for providing data or making adjustments or providing parameters for a wide variety of functions in the control unit. A prerequisite for this is the availability of a corresponding simulation, which can determine all the curves that are decisive for the function. The fewer dependencies the function has on other functions, the more promising this approach is.

The explanations given for the method apply to the apparatus accordingly. In this regard, any linguistic modifications of features formulated in terms of the method can be reformulated for the apparatus in accordance with standard linguistic practice, without such formulations having to be explicitly listed here. With the present method, it is preferably suggested that the machine learning model outputs as ideal a parameterization of the target curve as possible by using target curves of a vehicle, in order to implement parameter setting or calibration of a control device of the vehicle based on these target curves.

The calibration of a control device in a vehicle preferably describes the process in which specific parameters, settings, and/or data are programmed into the control device in order to adjust its function to the requirements of the vehicle and its components. Preferably, characteristic fields are defined that, for example, control the behavior of the engine, transmission, or brakes, such as torque characteristics, injection timings, or shifting strategies. Additionally, control parameters are configured that determine the behavior of control algorithms, such as in ABS or ESP systems. Vehicle-specific adjustments, for example for the air conditioning, seat heating, or assistance systems, are also possible. Preferably, diagnostic data is also set to detect and log errors. This process is preferably carried out both during production of the vehicle and at the time of later updates and/or optimizations, for example in the context of a software update.

Preferably, a disclosure is also made herein for a control unit, the (setting) parameters of which were determined based on the present method, or the control unit was calibrated with parameters generated using the machine learning model.

In another aspect, it is proposed that the ideal measurement curves be provided as mathematical models and/or experimental reference data captured during a test drive with the vehicle and/or as expert-defined curves.

For many functions in the control unit, it is difficult to define a specific target value that results in a specific target curve or (ideal) measurement curve. It is possible to specify, for example, for a specified drive cycle (corresponding to a function of the control device), how the vehicle or vehicle component should optimally behave, for example, by defining the optimal measurement curves (which are relevant to the corresponding function) for the cycle. These optimal measurement curves can be manually defined and/or measured based on a vehicle that has already been applied (e.g., a predecessor model). The advantage of the last mentioned procedure is that the “DNA” of a customer or vehicle behavior associated with it is retained in this manner, because the new vehicle then feels like the predecessor model while driving or using it. These ideal measurement curves may also be utilized when significant components of the vehicle are changing, for example, when a predecessor model is a combustion vehicle and a new vehicle has an electric drive system, so the approach is very flexible. In addition, certain portions of the ideal measurement curve(s) may be adjusted after a further measurement or simulation, if necessary.

The ideal measurement curves are preferably provided as mathematical models that describe the target curve exactly or approximately. Alternatively, the ideal measurement curves may preferably be stored as experimental reference data based on real-world measurements. Preferably, the ideal measurement curves may also be expert-defined curves that meet the requirements of the application.

Once these ideal measurement curves or target curves are defined and preferably a simulation model of the vehicle is present, which comprises all parameters that are important for the function considered and can determine the measurement curves considered, and/or a defined drive cycle can be driven in a real vehicle, for example, the machine learning model can be trained as described herein.

In a further aspect, it is proposed that the deviation between the simulated and/or captured measurement curves and the ideal measurement curves be quantified by way of an error function, in particular by a mean squared error, mean absolute error, cross-entropy, and/or a domain-specific error function.

The deviation between the simulated and/or captured measurement curves and the ideal measurement curves is preferably quantified by way of an error function. Preferably, a mean squared error (MSE) function is used to weight large errors more. Alternatively, a mean absolute error (MAE) function may preferably be employed to evaluate linear deviations. For classification problems, a cross-entropy function is preferably used. Preferably, a domain-specific error function can also be defined that takes into account particular requirements of the application.

In another aspect, it is suggested that the agent is trained based on a deep reinforcement learning approach, particularly using a deep Q network (DQN), a policy gradient method, or an actor-critic model.

The agent is preferably trained based on a deep reinforcement learning approach to learn complex relationships between parameter settings and measurement curves. Preferably, a deep Q network (DQN) is used to optimize states and actions in a discrete space. Alternatively, a policy gradient method may preferably be employed to model continuous actions. Preferably, an actor-critic model is used to improve the stability and efficiency of the training.

In another aspect, it is suggested that supervised learning occurs by way of a neural network that is implementable as a feedforward network, convolutional neural network (CNN), and/or transformer model.

Supervised learning is preferably realized by a neural network implemented as a feedforward network. Preferably, a convolutional neural network (CNN) is utilized to better detect local patterns and characteristics in the measurement curves. Alternatively, a transformer model may preferably be employed to model long-term dependencies in the data.

In a further aspect, it is proposed that the initial parameter settings of the control device be generated by a sampling method, in particular Monte Carlo sampling and/or Latin Hypercube sampling.

The initial parameter settings are preferably generated by a sampling method to ensure a wide coverage of the parameter space. Preferably, Monte Carlo sampling is used for this purpose to generate random parameter combinations. Alternatively, Latin Hypercube sampling may preferably be employed to ensure even distribution of the parameter values.

In another aspect, it is proposed that the simulated and/or captured measurement curves be subject to preprocessing prior to comparison with the ideal measurement curves, in particular by smoothing, normalizing, Fourier transformation, and/or eliminating measurement noise.

The simulated and/or captured measurement curves are preferably smoothed prior to comparison with the ideal measurement curves to eliminate measurement noise. Preferably, the measurement curves are normalized to scale them to a uniform range of values. Alternatively, the measurement curves may preferably be processed by Fourier transformation to extract frequency contents. Preferably, segmentation is also applied to better work out local patterns in the measurement curves.

In another aspect, it is proposed that the measurement curves be preprocessed by way of vectorization to be processable by the machine learning model.

Preferably the continuous data points of the measurement curves are converted into discrete values having a fixed length and structure. This is preferably done by sampling the measurement curve at regular intervals to ensure uniform representation of the curve. To normalize the values, preferably a scaling is applied, for example to a range of values between 0 and 1, to make the data more comparable. The data points of the measurement curves can also be simply arranged in a row. Furthermore, preferably characteristics of the measurement curve, such as extremities, slopes, or frequency contents, may be extracted and presented as vectors.

A Fourier or wavelet transform is preferably employed to capture frequency information of the curve and represent it as a characteristic vector. For higher accuracy, the measurement curve may preferably be segmented into multiple sections, wherein each section is vectorized separately to better account for local patterns or characteristics. The resulting vectors are preferably brought to a uniform dimension to ensure consistent input into the machine learning model. Finally, preferably data reduction techniques such as principal component analysis (PCA) may be employed to reduce the dimensionality of the vectors and remove redundant information, further increasing the efficiency of the model. The vectorization of the measurement curves may preferably occur by juxtaposing the (equal-length) measurements or by way of a particular algorithm, such as TS2Vec, a CNN, or the like.

In a further aspect, a control unit is also disclosed which is comprised in a vehicle having an autonomous driving function and/or a robotic system and/or an industrial machine, and on which the present method is executable in one of its aspects.

In a further aspect, a computer program comprising program code is disclosed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible embodiments, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

FIG. 1 shows a schematic flowchart of a method according to an exemplary embodiment.

FIG. 2 shows a schematic flowchart of a method according to an exemplary embodiment.

FIG. 3 shows a schematic block diagram of an exemplary embodiment of the method.

In the figures of the drawings, identical reference numbers denote identical or functionally identical elements, parts or components, unless stated otherwise.

### DETAILED DESCRIPTION

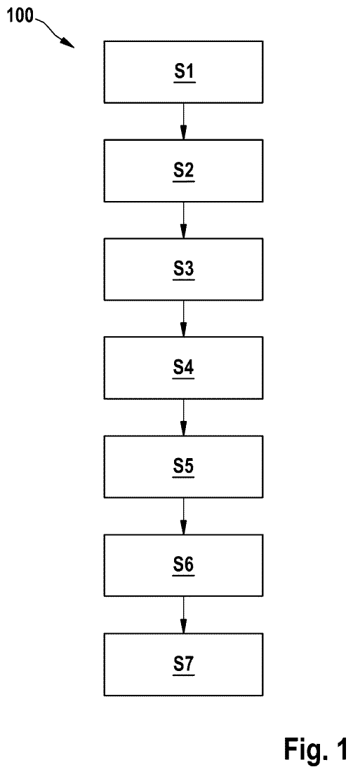

FIG. 1 shows a schematic flow chart of a method for training a machine learning model for determining optimal parameter settings of a control device of a vehicle, in particular based on reinforcement learning.

The computer-implemented method comprises at least the following steps:

In a step S1, an agent model is provided that generates actions in the form of parameter settings for the control device.

In a step S2, the agent model is initialized with random or predetermined parameter settings.

In a step S3, the measurement curves are simulated or captured based on the parameter settings suggested by the agent and the ideal measurement curves are provided.

In a step S4, a reward signal is calculated by comparing the simulated and/or captured measurement curves with previously known ideal measurement curves, wherein the reward signal quantifies the deviation between the simulated and/or captured measurement curves and the ideal measurement curves.

In a step S5, a policy of the agent model is adjusted based on the reward signal to select future parameter settings to minimize the deviation.

In a step S6, the steps of simulation or capture, reward calculation and policy adjustment are repeated up to a convergence condition occurs where the simulated and/or captured measurement curves are within a predetermined tolerance range of the ideal measurement curves.

In a step S7, the trained agent model is provided.

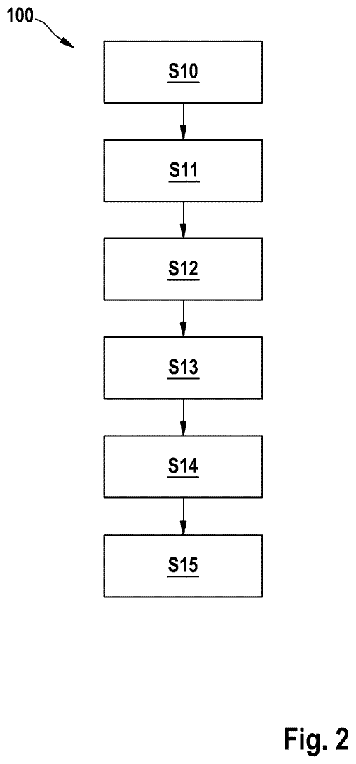

FIG. 2 shows a schematic flow chart of a method for training a machine learning model for determining optimal parameter settings of a control device of a vehicle, in particular based on supervised learning.

The computer-implemented method comprises at least the following steps:

In a step S10, a training data set is provided that comprises a plurality of input data in the form of parameter settings as well as associated measurement curves and ideal measurement curves.

In a step S11, the machine learning model is trained by adjusting model parameters, wherein the machine learning model is trained to predict parameter settings using the measurement curves and the ideal measurement curves.

In a step S12, an error signal is calculated based on a deviation between the predicted measurement curves and the ideal measurement curves.

In a step S13, the model parameters are optimized by minimizing the error signal using an optimization algorithm.

In a step S14, the training process is repeated until a convergence condition occurs where the machine learning model outputs parameter settings that result in measurement curves that are within a predetermined tolerance range of the ideal measurement curves.

In step S15, the trained machine learning model is provided.

The respective methods can each be carried out in any embodiment, at least in part, by an apparatus 100 which may comprise several components not shown in detail, for example one or more provision devices and/or at least one evaluation and calculation unit. It is understood that the provision device may be configured together with the evaluation and calculation unit or may be separate from it. Furthermore, the apparatus 100, which may be part of a system, may comprise a storage device and/or an output device and/or a display device and/or an input device.

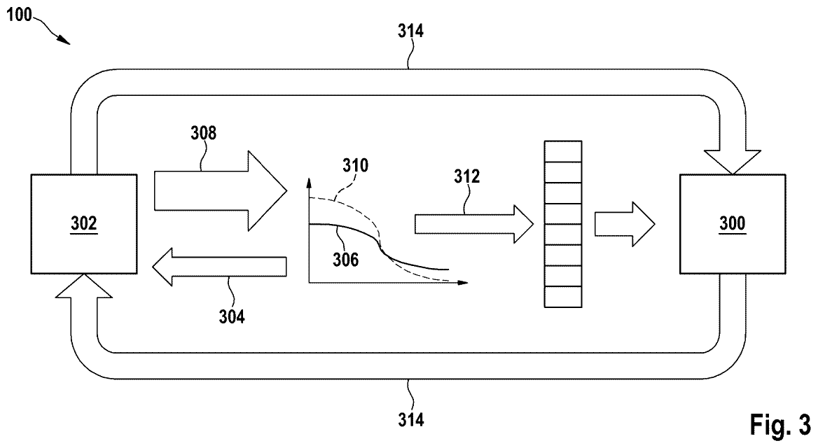

FIG. 3 shows a schematic set-up of a training method executable on the apparatus 100. A machine learning model 300, which may be configured as an agent model, is trained to determine optimal parameter settings of a control device of a vehicle, in particular based on reinforcement learning.

The machine learning model 300, in particular the agent model, can thereby generate actions in the form of parameter settings for the control device.

First, for example, the agent model is initialized with parameters 302 using random or predetermined parameter settings. These parameters are considered to be parameters suggested by the agent. Randomization is labeled 304. Then, measurement curves 306 are simulated or measured (through a test drive) based on these randomized parameters 302. Simulating or test driving is indicated by the arrow 308. Furthermore, ideal measurement curves 310 are provided. The measurement curves are preferably vectorized, indicated by the arrow 312.

A reward signal is calculated by comparing the simulated and/or captured measurement curves 306 with previously known ideal measurement curves 310, wherein the reward signal quantifies the deviation between the simulated and/or captured measurement curves 306 and ideal measurement curves 310. Then, a policy of the agent model 300 is adjusted based on the reward signal to select future parameter settings to minimize the deviation.

The steps of simulation or capture, reward calculation, and policy adjustment are performed (in the loop) until a convergence condition occurs where the simulated and/or captured measurement curves 306 are within a predetermined tolerance range of the ideal measurement curves 310. This repeating is indicated by the arrows 314.

What is claimed is:

1. A method for training a machine learning model for determining optimal parameter settings of a control device of a vehicle based on reinforcement learning, the method comprising:
providing an agent model that generates actions in the form of parameter settings for the control device;
initializing the agent model with random or predetermined parameter settings;
simulating and/or capturing measurement curves based on the parameter settings suggested by an agent and providing ideal measurement curves;
calculating a reward signal by comparing the simulated and/or captured measurement curves with previously known ideal measurement curves, wherein the reward signal quantifies the deviation between the simulated and/or captured measurement curves and the ideal measurement curves;
adjusting a policy of the agent model based on the reward signal to select future parameter settings to minimize the deviation;
repeating the steps of simulation or capture, reward calculation, and policy adjustment until a convergence condition occurs where the simulated and/or captured measurement curves are within a predetermined tolerance range of the ideal measurement curves; and
providing the trained agent model.

2. A method for training a machine learning model for determining optimal parameter settings of a control device of a vehicle based on supervised learning, comprising:
providing a training data set comprising a plurality of input data in the form of parameter settings as well as associated simulated and/or captured measurement curves and ideal measurement curves;
training the machine learning model by adjusting model parameters, wherein the machine learning model is trained to predict parameter settings using the measurement curves and the ideal measurement curves;
calculating an error signal based on a deviation between the simulated and/or captured measurement curves and the ideal measurement curves;
optimizing the model parameters by minimizing the error signal using an optimization algorithm;
repeating the training process until a convergence condition occurs where the machine learning model outputs parameter settings that result in simulated and/or captured measurement curves that are within a predetermined tolerance range of the ideal measurement curves; and
providing the trained machine learning model.

3. The method according to claim 1, wherein the ideal measurement curves are provided as mathematical models and/or experimental reference data captured during a test drive with the vehicle and/or as expert-defined curves.

4. The method according to claim 1, wherein the deviation between the simulated and/or captured measurement curves and the ideal measurement curves is quantified by an error function.

5. The method according to claim 1, wherein the agent is trained based on a deep reinforcement learning approach using a deep Q network, a policy gradient method, or an actor-critic model.

6. The method according to claim 2, wherein the supervised learning occurs by way of a neural network that is implementable as a feedforward network, convolutional neural network, and/or transformer model.

7. The method according to claim 1, wherein the initial parameter settings of the control device are generated by a sampling method.

8. The method according to claim 1, wherein the simulated and/or captured measurement curves are subjected to preprocessing prior to comparison with the ideal measurement curves.

9. An apparatus for training a machine learning model for determining optimal parameter settings of a control device of a vehicle, comprising:
a computational unit configured to implement the method according to claim 1;
a data interface configured to provide simulated and/or captured measurement curves and ideal measurement curves; and
an output unit configured to output the trained parameter settings.

10. A computer program product comprising instructions which, when executed by a computational unit, executes the method according to claim 1.

11. The method according to claim 2, wherein the ideal measurement curves are provided as mathematical models and/or experimental reference data captured during a test drive with the vehicle and/or as expert-defined curves.

12. The method according to claim 1, wherein the deviation between the simulated and/or captured measurement curves and the ideal measurement curves is quantified by a mean squared error, mean absolute error, cross-entropy, and/or a domain-specific error function.

13. The method according to claim 7, wherein the sampling method includes Monte Carlo sampling and/or Latin Hypercube sampling.

14. The method according to claim 1, wherein the simulated and/or captured measurement curves are subjected to preprocessing prior to comparison with the ideal measurement curves by smoothing, normalizing, Fourier transformation, and/or eliminating measurement noise.

15. An apparatus for training a machine learning model for determining optimal parameter settings of a control device of a vehicle, comprising:
a computational unit configured to implement the method according to claim 2;
a data interface configured to provide simulated and/or captured measurement curves and ideal measurement curves; and
an output unit configured to output the trained parameter settings.

16. A computer program product comprising instructions which, when executed by a computational unit, executes the method according to claim 2.
